(19) United States
(12) Patent Application Publication
(10) Pub. No.: US 2026/0073245 A1
(43) Pub. Date: Mar. 12, 2026

(54) VALUE PREDICTION

(71) Applicant: Arm Limited, Cambridge (GB)

(72) Inventor: Rami Mohammad AL SHEIKH, Morrisville, NC (US)

(21) Appl. No.: 18/829,725

(22) Filed: Sep. 10, 2024

(51) Int. Cl. G06N 5/022

(52) U.S. Cl. CPC G06N 5/022

(57) ABSTRACT

An apparatus comprises processing circuitry to perform data processing operations in response to instructions; a register file comprising registers configured to store operands for instructions processed by the processing circuitry; and value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction. The value prediction circuitry uses the register file as a store of predicted result data values. The data value prediction generated by the value prediction circuitry indicates a selected register of the register file from which the processing circuitry is to obtain the predicted result data value when processing the at least one dependent instruction.

### BACKGROUND

### Technical Field

The present technique relates to the field of data processing.

### Technical Background

A processing apparatus may have value prediction circuitry for generating a data value prediction indicating a predicted result data value for a given instruction before the actual result data value is available. This can help other instructions dependent on the predicted instruction execute earlier based on the predicted result data value, which can improve performance if the data value prediction is correct.

### SUMMARY

At least some examples of the present technique provide an apparatus comprising:
processing circuitry to perform data processing operations in response to instructions;
a register file comprising registers configured to store operands for instructions processed by the processing circuitry; and
value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
the value prediction circuitry is configured to use the register file as a store of predicted result data values; and
the data value prediction generated by the value prediction circuitry indicates a selected register of the register file from which the processing circuitry is to obtain the predicted result data value when processing the at least one dependent instruction.

At least some examples of the present technique provide a system comprising:
the apparatus described above, implemented in at least one packaged chip;
at least one system component; and
a board,
wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus comprising:
processing circuitry to perform data processing operations in response to instructions;
a register file comprising registers configured to store operands for instructions processed by the processing circuitry; and
value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
the value prediction circuitry is configured to use the register file as a store of predicted result data values; and
the data value prediction generated by the value prediction circuitry indicates a selected register of the register file from which the processing circuitry is to obtain the predicted result data value when processing the at least one dependent instruction.

At least some examples of the present technique provide a method comprising:
performing, using processing circuitry, data processing operations in response to instructions, based on operands stored in registers of a register file; and
generating, using value prediction circuitry, a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
the value prediction circuitry uses the register file as a store of predicted result data values; and
the data value prediction generated by the value prediction circuitry indicates a selected register of the register file from which the processing circuitry is to obtain the predicted result data value when processing the at least one dependent instruction.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising value prediction circuitry;

FIG. 2 illustrates how value prediction can increase instruction-level parallelism by breaking dependencies between instructions;

FIG. 3 illustrates a method for data value prediction;

FIG. 4 illustrates an example of a value prediction table;

FIG. 5 illustrates an example of steps for value prediction training;

FIG. 6 illustrates an example of steps for generating a data value prediction;

FIG. 7 illustrates an example of a filter structure; and

FIG. 8 illustrates a system and a chip-containing product.

### DESCRIPTION OF EXAMPLES

An apparatus has processing circuitry to perform data processing operations in response to instructions; and value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction.

While in theory such data value predictions may improve performance by enabling dependencies between the given instruction and the dependent instructions to be broken, in practice performance improvement may rely on the data value predictor giving extremely high prediction accuracy (e.g. in some cases, over 99% accuracy) because the cost of a misprediction is very high and so accuracy below that threshold tends to result in performance degradation. This is because if a number of dependent instructions are executed based on mispredicted result data value of the given instruction, then by the time the misprediction is detected, instructions younger than the incorrectly predicted instruction are flushed, refetched and re-executed executed based on the actual result data value of the given instruction, the delay in successfully committing those instructions is much greater than would have been the case if the data value prediction had never been made and instead the dependent instructions had simply waited for the actual result data value to be obtained for the given instruction. As the cost of misprediction is higher for data value prediction compared to other prediction mechanisms (such as branch prediction), this often means that, to provide any performance benefit, a significant circuit area and power cost may need to be incurred to support the required level of prediction accuracy. In typical value prediction schemes, a large part of this circuit area and power cost may be in maintaining a prediction table structure which stores the predicted result values for a number of instructions. As the predicted result values can be large (e.g. 64 bits or more per result value), this may require a large amount of storage and also may incur a significant power cost in transferring predicted result values between the prediction table structure and the registers or execution units at which the predicted values are consumed by dependent instructions. Given the high circuit area and power cost required for sufficiently accurate data value prediction and the severe consequences to performance of mispredictions, implementations with a limited budget for circuit area and power cost may simply choose not to use value prediction at all. Hence, the “barriers to entry” are relatively high for the adoption of data value prediction, and design tradeoffs in processor micro-architecture design may mean the cost of conventional value prediction schemes is prohibitive.

The inventor has proposed a different approach whereby a register file, comprising registers configured to store operands for instructions processed by the processing circuitry, is reused as a store of predicted result data values for use in generation of data value predictions using the value prediction circuitry. Hence, when the value prediction circuitry generates a data value prediction for a given instruction, the data value prediction indicates a selected register of the register file from which the processing circuitry is to obtain the predicted result data value when processing the at least one dependent instruction.

Modern processing systems typically have a register file which comprises a greater number of physical registers than is actually required to hold the architectural state of the processor at any given time. Register renaming techniques can be used to map logical registers referenced by instructions to physical registers of the register file, to improve performance by eliminating false register dependencies caused by having to reuse logical registers as there are only a limited number of logical registers available in the instruction set architecture supported by the processing circuitry. Hence, there can be spare registers available in the register file that can be used to hold predicted result data values which do not represent the current architectural state corresponding to a given logical register, but which instead are predicted values captured at a previous time that could be reused later if it is predicted that a given instruction is likely to generate that predicted value as its result. Reusing registers of the register file to hold the predicted data values can support a reduction in the number of bits to be maintained by the value prediction circuitry in any prediction table structures.

Also, the power cost of transferring a predicted data value stored in the register file to another register or to an execution unit of the processing circuitry is typically lower than when transferring data from a separate value prediction table to a source register of a dependent instruction or to an execution unit. By using the register file as a store of predicted result data values, the power cost of data value prediction can therefore be reduced as it reduces the need for costly transfers of full-width result data values between prediction tables maintained by the value prediction circuitry and the processing circuitry or register file.

Hence, the use of the register file as a store of predicted result data values for the value prediction circuitry can greatly reduce the power and circuit area cost of implementing value prediction when supporting a given level of prediction accuracy, reducing the barriers to entry of using value prediction, and so making it more likely that processor implementations with a limited power and circuit area budget can use value prediction, to improve the processing performance achievable with that power and circuit area budget.

The given instruction whose result data value is predicted could be any instruction which generates a value for a given destination register which can be referenced as a source operand by a dependent instruction. For example, the given instruction could be an arithmetic/logical instruction for which the processing circuitry performs an arithmetic/logical operation to generate the result data value. The given instruction could also be a load instruction which causes the processing circuitry to issue a load request to a cache or memory system to cause the result data value to be loaded to a given destination register.

In some examples, the value prediction circuitry is configured to maintain a value prediction table comprising at least one value prediction entry, each value prediction entry comprising at least one value prediction field. The value prediction circuitry may be configured to generate, for the given instruction, the data value prediction specifying a register identifier read from a value prediction field of an entry of the value prediction table corresponding to the given instruction. Hence, by storing register identifiers in the value prediction table (rather than the value prediction table storing the actual predicted result data values themselves), a more energy-efficient table structure can be provided, and also the energy cost of transferring bits of information representing the data value prediction between the value prediction circuitry and the processing circuitry can be reduced (as a smaller register identifier can be transferred in place of the full result data value itself). Hence, each value prediction field may have fewer bits than a number of bits in the predicted result data value.

In some examples, during a training phase, the value prediction circuitry may record, in a given value prediction field of the given value prediction entry, a result hash value obtained by applying a hash function to a result data value obtained by the processing circuitry for an associated instruction associated with the given value prediction entry. The training phase may be a phase when the given value prediction entry still has insufficient confidence to be able to use the given value prediction entry for generating data value predictions.

The inventor recognised that, while storing register identifiers in the value prediction table can be beneficial during a prediction phase once a given value prediction entry has reached sufficient confidence to use that entry for generating data value predictions, if register identifiers were also stored in the value prediction table during a training phase (and so the corresponding predicted data values being trained were held in the register file), then this could greatly increase register pressure on the register file. There can be many entries of the value prediction table which do not succeed in the training phase (and never reach the required threshold confidence), so consuming registers of the register file for storing the predicted data values for such value prediction entries that end up failing the training would be likely to require a large number of physical registers to be occupied in storing predicted data values, which are therefore not available for storing regular instruction operands and results. As there may be a limit to how much the register file can be increased in size, given available circuit area and power budget, increased register pressure is likely to harm performance as it makes it more likely that instructions have to stall because when they reach a register rename stage there are no free registers available for allocation.

Hence, it may be undesirable to use register references to represent data value predictions during the training phase, but if the full data values were stored in the value prediction table during training, the table would become larger negating some of the benefit of storing register identifiers in the entries which have successfully completed training. The inventor recognised that, during the training phase of a given prediction table entry, a value prediction field which (if training successfully completes) would be used to store the register identifier can be reused to store a result hash value obtained by applying a hash function to the result data value for an associated instruction. The result hash value may have fewer bits than the result data value itself and so can fit in a field designed for holding register identifiers. This avoids the need to reserve registers of the register file for holding predicted data values corresponding to value prediction entries still undergoing training, reducing register pressure and therefore improving performance.

The result hash value can then be used for comparisons against a hash of a subsequent result generated for the same associated instruction, to train the predictor based on whether the result is consistent. Hence, during the training phase, the value prediction circuitry may adjust confidence in the given value prediction entry based on a comparison of the result hash value with an actual result hash value obtained by the processing circuitry by applying the hash function to an actual result data value obtained by the processing circuitry for the associated instruction. The value prediction circuitry may increase confidence in the given value prediction entry in response to the comparison detecting a match between the result hash value and the actual result hash value, and may decrease confidence in the given value prediction entry in response to the comparison detecting a mismatch between the result hash value and the actual result hash value. The use of a hash function to compress the results data value into a smaller hash value may mean that there is a given (non-zero) probability that there could be false positive detection of a match between the result hash value and the actual result hash value even though the corresponding result values from which the compared hash values were generated did not match each other. However, in practice, such occasional false positive hash matches may be statistically unlikely to occur repeatedly for the same value prediction entry, so are unlikely to lead to prediction errors in an entry which has reached sufficient confidence to complete training.

Following completion of the training phase, in response to detecting a given instance of the associated instruction when a given value prediction field corresponding to the given instance of the associated instruction specifies the result hash value, the value prediction circuitry is configured to replace the result hash value stored in the given value prediction field with a register identifier identifying a register of the register file assigned to store an actual result data value obtained by the processing circuitry for the given instance of the associated instruction. Hence, once training has successfully completed (e.g. once confidence in the given value prediction entry has reached a confidence threshold) and an instance of the associated instruction has its result written to a given register, the hash can be replaced with a register identifier of the given register so that subsequent value predictions can reference that result as a predicted data value.

In response to detecting a given instance of an associated instruction associated with a given value prediction entry after a training phase is complete for the given value prediction entry, when a given value prediction field of the given value prediction entry corresponding to the given instance of the associated instruction specifies a given register identifier identifying a given register, the value prediction circuitry may break a dependency between the given instance of the associated instruction and at least one dependent instruction to enable the dependent instruction to execute using the given register as a source register before an actual result data value for the given register is obtained by the processing circuitry in response to the given instance of the associated instruction. Hence, once the hash in a given value prediction field has been replaced by a register identifier, subsequent instances of instructions corresponding to that given value prediction field can cause a data value prediction to be generated so that a dependent instruction can execute earlier based on the value in the register identified by the register identifier stored in the given value prediction field.

In some examples, each value prediction entry corresponding to an associated instruction may provide a single value prediction field for recording a hash value or register identifier corresponding to a predicted result data value for that instruction.

However, in some examples, each value prediction entry comprises a plurality of value prediction fields corresponding to respective instances of processing an associated instruction. For example, the respective instances of processing the associated instruction correspond to different loop iterations. This recognises that the same instruction (at a given program counter address) may be executed multiple times in a loop and may give different result data values for different iterations of the loop. Therefore, by identifying which particular instance of the instruction is executed (e.g. based on tracking loop iterations), and providing support for multiple value prediction fields per instruction at a given program counter address, it is more likely that accurate value predictions are possible to enable different predicted data values to be generated for the different instances of the instruction. With conventional value prediction schemes recording the actual predicted data values themselves in the prediction table, the cost of multiple value prediction fields to store two or more data values per instruction would likely be prohibitive given the wide data values in use in modern processing systems, but the inventor has recognised this becomes feasible when the predicted data values are represented by register identifiers stored in the prediction table rather than storing the data values themselves.

To enable the respective instances of a given instruction to be distinguished for the purpose of looking up the value prediction table, the apparatus may have instance identifier assignment circuitry configured to assign, to an instruction associated with a given program counter address, an instance identifier for distinguishing respective instances of the instruction associated with the given program counter address. The value prediction circuitry can select between the value prediction fields of a given value prediction entry based on the instance identifier associated with an instruction associated with the given value prediction entry.

When registers of the register file are used to store predicted data values for use by the value prediction circuitry in predicting the result data value of a given instruction, it may be desirable that the register storing the predicted data value is protected against reallocation for a period to increase the likelihood that this register is still storing the predicted data value when a subsequent instance of the given instruction that can benefit from the value prediction is encountered. Register rename circuitry may be provided to map logical registers referenced by instructions to physical registers of the register file. There may be a constant pressure for registers to become available for reallocation to a logical register, and in the absence of any protective action, it may be that the natural lifetime with which the register used to store the predicted data value remains available before reallocation is too short to enable performance improvement due to the value prediction. Hence, in some examples, the register rename circuitry may perform a protective action to reduce probability of a given physical register identified in the value prediction table being remapped for storing a value other than the given predicted data value.

The protective action can be implemented in different ways. In some examples, the protective action comprises reducing a reclaim priority with which the given physical register is selected for being remapped. For example, the register rename circuitry may maintain a “free list” indicating which physical registers are available for being remapped. The free list may define, for each register, some order of priority in which the physical registers should be selected for remapping. For example, the free list may be implemented as a queue where registers nearest the front of the queue are more likely to be selected for remapping than registers nearer the back of the queue, or alternatively the free list may be a structure defining a reclaim priority value for each register. Registers previously allocated for an actual result data value of an instruction may be reclaimed and allocated to the free list once the register rename circuitry detects that there can be no remaining instruction which still needs to reference that register for its instruction operand. For the register used to hold a predicted data value, the timing at which reclaim may happen is relatively arbitrary as there may be no instruction required to reference the predicted data value (if the predicted data value is lost then the alternative is simply to not use value prediction for the corresponding instruction). Therefore, there is flexibility to vary the point at which the register holding the predicted data value is reclaimed or the relative priority with which that register is selected for remapping. One way of protecting that register against remapping for a period can be to demote the register in the free list, to reduce the reclaim priority. This demotion could occur more than once as other registers become free in the free list, to keep reducing from time to time the reclaim priority of the register holding the value prediction. This prolongs the lifetime of the given physical register used to hold the predicted data value, increasing the likelihood that a subsequent instruction can benefit from the data value prediction to improve performance.

In some examples, the protective action comprises designating, as the given physical register identified in the value prediction table for providing the given predicted data value, a register in a protected portion of the register file which is reserved for representing the store of predicted data values. Hence, a portion of the register file may be reserved for predicted data values only and may not be able to be reclaimed to store the actual architectural value of a given logical register. With this approach, at the point when a register identifier would be written to the value prediction table to record the register used to capture the result of a given instruction, the value prediction circuitry may trigger a register-to-register move operation to move the result of that instruction from the physical register designated as the destination register of the instruction to a selected register within the protected portion of the register file. Replacement of registers in the protected portion may be performed only to accommodate other predicted data values (rather than for accommodating standard instruction results). Replacement of registers in the protected portion can be based on a replacement policy which considers the prediction confidence tracked by the value prediction table for the corresponding value prediction entry, to cause the protected portion to be reserved for those predicted data values with the highest confidence. With this approach, register pressure from regular instructions seeking reclaim of a register for storing the actual (non-predicted) architectural value corresponding to a given logical register does not affect the lifetime of the register holding a predicted data value, hence increasing the lifetime of the registers providing predictions and making it more likely a later instruction can benefit from the prediction recorded in response to an earlier instruction.

Regardless of which approach is taken (or whether any protective action for prolonging lifetime of registers used to hold value predictions is implemented at all), there may still be a risk that eventually a register used to hold a predicted data value is reclaimed and reallocated for a different purpose (e.g. for mapping to the destination logical register of a particular instruction). This may happen even in the approach where registers holding a prediction data value are demoted in the free list, since eventually it may be that there are no registers available for remapping other than those holding a predicted data value, in which case register pressure may demand that performance is more likely to be improved by remapping the register holding the predicted data value rather than continuing to protect the register holding the predicted data value against reclaim.

Hence, in response to a given physical register, which is identified in the value prediction table as representing a given predicted data value, being remapped for storing a value other than the given predicted data value, the value prediction circuitry may invalidate at least one value prediction field identifying the given physical register in the value prediction table. This prevents value predictions continuing to reference the given physical register after that register is no longer used to hold the predicted data value represented by that value prediction.

The process for invalidating a field referencing a given physical register from the value prediction table may be relatively slow and energy intensive as it may require walking through each entry of the value prediction table to check whether that entry references the given physical register. However, on many occasions when a register is reclaimed, it may be that the reclaimed register is not actually referenced in the value prediction table and the energy cost of the invalidation sweep may be wasted. Therefore, to improve performance efficiency of maintaining the value prediction table, it can be helpful to provide a filter structure which identifies whether any given physical register is identified in the value prediction table. In response to the given physical register being remapped for storing a value other than the given predicted data value, the value prediction circuitry may look up the filter structure to identify whether the given physical register is identified in the value prediction table; and in response to the lookup of the filter structure identifying that the given physical register is identified in the value prediction table, trigger a search procedure to search for any value prediction fields identifying the given physical register which are to be invalidated. The search procedure can be suppressed if the lookup of the filter structure indicates that the given physical register is not identified in the value prediction table, thus saving energy by avoiding unnecessarily performing the search procedure.

In some examples, the value prediction circuitry could maintain the value prediction table based on results generated by non-flushed instructions which successfully commit as they were determined to be correctly executed.

However, in some examples, the value prediction circuitry is configured to maintain the value prediction table based on training performed based on result data values obtained by the processing circuitry for flushed instructions which are flushed from a processing pipeline following detection of a misprediction. It may seem surprising that it would be useful to maintain the value prediction table based on results of flushed instructions, which by definition may be instructions at risk of being incorrectly processed. However, in practice, the inventor recognised that often the cause of the flush of a given flushed instruction may not necessarily be related to any error in that instruction itself (or in any instruction on which the given flushed instruction depends), but might be a consequence of an earlier misprediction that does not actually affect the result of the given flushed instruction. For example, if there is an earlier branch misprediction, sometimes it may be that both the correct and incorrectly selected paths of program flow following the branch re-converge before a given flushed instruction and the flushed instruction provides the same result regardless of which branch path is taken. This can be particularly helpful when executing a loop, where despite an error in branch prediction arising on one loop iteration, the outcomes of instructions in subsequent loop iterations executed speculatively before the branch misprediction was discovered may still be correct. Hence, valuable information can be learned from the speculatively executed instructions which were flushed which can be used for prediction when those instructions are replayed later. It has been found that value predictions for such flushed/replayed instructions may generally give higher value prediction accuracy than is possible for attempting to predict data values for a given instruction based on earlier non-flushed instances of processing the same given instruction. That is, the consistency of result data values may be higher between the flushed attempt at processing the instruction and a subsequent replay attempt of executing the same instance of the instruction following resolution of a misprediction, than is likely between one non-flushed instance of the instruction and a subsequent non-flushed instance of the instruction.

Hence, in some examples, maintenance of the value prediction table may be exclusively based on training performed based on result data values obtained by the processing circuitry for flushed instructions (as well as based on instructions that actually cause a data value misprediction, even if the value-mispredicted instructions are not themselves flushed). The maintenance of the value prediction table may be independent of a result data value obtained by an instruction which commits without being flushed and which is not subject to any value misprediction. This can help reserve the use of value prediction for the scenarios when accuracy is likely to be highest, to reduce the likelihood that the high misprediction penalty described above is incurred.

In some examples, the data value prediction may provide a register identifier identifying a single predicted result data value for a given instruction.

However, it is also possible that, in response to a given type of instruction specifying a plurality of destination registers for storing a plurality of result data values to be obtained in response to the given type of instruction, the value prediction circuitry is capable of generating data value predictions for at least two of the result data values of a given instance of the given type of instruction. For example, the given type of instruction could be a load-multiple instruction which loads multiple destination registers with respective data values obtained from memory. The load-multiple instruction could be a load-pair instruction for which the number of destination registers is two, or could be a more generic load-multiple instruction which is capable of loading to a variable number of destination registers (the number of registers to be loaded being specified in the encoding of the instruction). With traditional value prediction schemes, the energy and circuit area cost of implementing value prediction for load-multiple instructions or other instructions using multiple destination registers would be prohibitive, because it would incur too much circuit area budget to support multiple value prediction fields per prediction table entry when each of those fields specifies a full-width predicted result data value. By reducing the size of the value prediction fields by using register references instead of storing the result data values in the prediction table itself, use of value prediction for instructions with multiple destination registers becomes more feasible.

In some examples, the register file comprises a vector register file comprising vector registers, and the value prediction circuitry is capable of generating the data value prediction indicative of a selected vector register of the vector register file from which the processing circuitry is to obtain a predicted vector result data value when processing the at least one dependent instruction. Vector registers may, in comparison to scalar registers, have extremely wide register widths, e.g. 128 bits, 256 bits, 512 bits, or more. Due to the wide vector registers, traditional value prediction schemes which record the predicted data value for a given register in the value prediction table would not be feasible for making value predictions for vector registers (and so would be limited to predicting result values for scalar registers), as it would be prohibitive to store many 128/256/512 bit data values in the prediction table and incur the energy cost of transferring such large data values between the prediction table and the compute logic of the processing circuitry. However, with the use of the register file for storing the predicted data values, the register identifiers stored in the prediction table have a bit-width that scales with the number of registers of the register file that are available for storing value predictions, and is independent of the width of those registers themselves, so that implementing value prediction for vector registers becomes feasible, enabling performance improvements that would have been inaccessible before.

Specific examples are now set out with reference to the drawings.

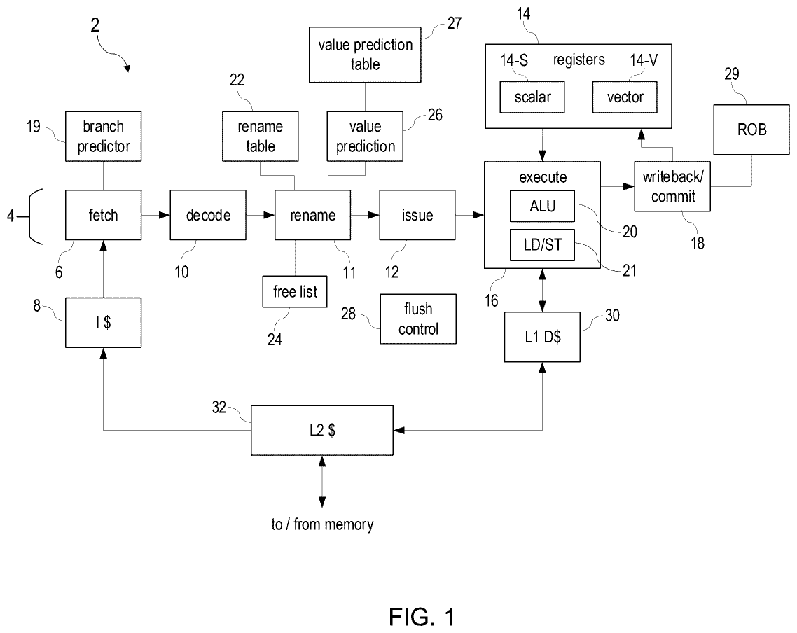

FIG. 1 schematically illustrates an example of a data processing apparatus 2. The data processing apparatus has a processing pipeline 4 which includes a number of pipeline stages. In this example, the pipeline stages include:
a fetch stage 6 for fetching instructions from an instruction cache 8.
a decode stage 10 for decoding the fetched program instructions to generate micro-operations (decoded instructions) to be processed by remaining stages of the pipeline.
a rename stage 11 for performing register renaming to map logical register identifiers specified by program instructions or micro-operations to physical register identifiers identifying physical registers in a register file 14. The rename stage 11 maintains a rename table 22 to track current logical-to-physical register mappings and a free list 24 to track physical registers which are available for reclaiming for remapping to a new logical register. When a micro-operation specifying a given destination logical register and one or more source logical registers reaches the rename stage 11, the rename stage 11 looks up current register mappings in the rename table 22 for each source logical register, to map each source logical register to a corresponding physical register, and allocates a new physical register selected from the free list 24 to the destination logical register of the micro-operation (updating the rename table 22 to account for the new mapping of the destination logical register to the new physical register).
an issue stage 12 for checking whether operands required for the micro-operations are available in the register file 14 and issuing micro-operations for execution once the required operands for a given micro-operation are available (or are guaranteed to be available by the time the micro-operation reaches the relevant execution unit).
an execute stage 16 for executing data processing operations corresponding to the micro-operations, by processing operands read from the register file 14 to generate result values.
a writeback/commit stage 18 for writing the results of the processing back to the register file 14 and committing instructions once they are guaranteed to be correctly executed. The writeback/commit stage 18 may use a reorder buffer 29 to track in-order commitment of instructions which may be executed by the execute stage 16 out-of-order (i.e. in an order different from program order).
   It will be appreciated that this is merely one example of possible pipeline architecture, and other systems may have additional stages or a different configuration of stages.

In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of execution units, for executing different classes of processing operation. For example the execution units may include an arithmetic/logic unit (ALU) 20 for performing arithmetic or logical operations on scalar operands read from the registers 14; and a load/store unit 21 for performing load/store operations to access data in a memory system 8, 30, 32. In this example, the memory system includes a level one data cache 30, the level one instruction cache 8, a shared level two cache 32 and main system memory (not shown in FIG. 1). It will be appreciated that this is just one example of a possible memory hierarchy and other arrangements of caches can be provided. Further examples of execution unit (not shown in FIG. 1 for conciseness) can include a branch unit for executing branch instructions, a floating-point unit for performing operations on numbers represented in a floating-point format, etc. The ALU 20 shown in FIG. 1 could be implemented with separate scalar ALU and vector ALU execution units for performing scalar and vector operations, with the scalar ALU processing scalar operands stored in scalar registers 14-S and the vector ALU processing vector operands stored in vector registers 14-V (in some examples the vector registers 14-V and scalar registers 14-S may correspond to separate instances of register files 14).

The specific types of execution unit discussed above for the execute stage 16 are just one example, and other implementations may have a different set of execution units or could include multiple instances of the same type of execution unit so that multiple micro-operations of the same type can be handled in parallel. It is not essential for the apparatus to support both scalar and vector processing (e.g. some examples may not support the vector ALU and vector registers 14-V). It will be appreciated that FIG. 1 is merely a simplified representation of some components of a possible processor pipeline architecture, and the processor may include many other elements not illustrated for conciseness.

The apparatus 2 also has a branch predictor 19 used to generate predictions of branch behaviour of branch instructions to be executed by the branch unit 24. The predictions provided by the branch predictor 19 may be used by the fetch stage 6 to determine the sequence of addresses from which instructions are to be fetched from the instruction cache 8 or memory system. Any known branch prediction technique may be used for the branch predictor 19.

The apparatus 2 also includes value prediction circuitry 26 used to generate a data value prediction representing a predicted result data value expected to be obtained by a given instruction, before that instruction has actually been processed by the execute stage 16. For example, an ALU instruction to be processed by the ALU 20 could have the result of the ALU operation (e.g. add, subtract, multiply, divide, square root, shift, AND, OR, etc.) predicted by the value prediction circuitry 26, or the load target data to be loaded by the load/store unit 21 in response to a load instruction could be predicted before the load data is actually returned from the memory system. The value prediction circuitry 26 uses a value prediction table 27 to store prediction information learnt from previous instruction execution that can be used to predict the result data value for an instruction on a subsequent occasion. When a value prediction is made for a given instruction, dependent instructions (instructions which have a source operand which depends directly or indirectly on the result data value of the given instruction) can execute earlier as the dependency on the given instruction can be broken.

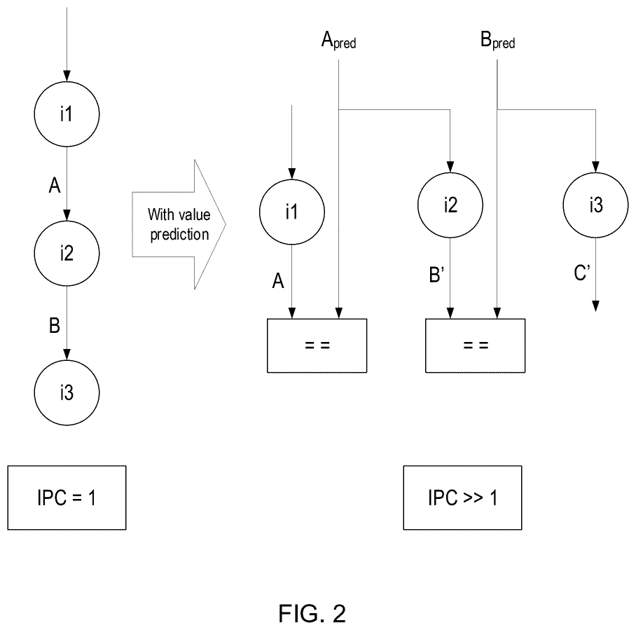

FIG. 2 illustrates the principle of data value prediction. The left-hand part of FIG. 2 illustrates execution of a sequence of instructions in the absence of value prediction, with a second instruction i2 being dependent on the result data value A of a first instruction i1, and a third instruction i3 being dependent on the result data value B of the second instruction i2 (hence, relative to instruction i1, both instructions i2 and i3 are dependent instructions which depend on instruction i1). In the absence of value prediction, the dependencies would constrain these instructions to be executed sequentially, so in the absence of any other independent instructions which could be executed in parallel with the instructions i1-i3, the number of instructions executed per cycle (IPC) would be 1.

The right-hand part of FIG. 2 illustrates how the same instructions i1-i3 can be executed in parallel when value prediction circuitry 26 is used to predict the result data values A and B of instructions i1 and i2. This allows instruction i2 to execute in parallel with instruction i1, based on an operand corresponding to the predicted result data value A_{pred} for instruction i1. Similarly, instruction i3 can execute in parallel with instruction i2, based on an operand corresponding to the predicted result data value B_{pred} for instruction i2. This generates speculative results B′ and C′ for instructions i2 and i3. Subsequently, once instruction i1 actually completes, comparison logic can compare the actual result data value A of instruction i1 with the predicted result data value A_{pred} for instruction i1, and signal a misprediction if there is a mismatch. Similarly, comparison logic can compare the actual result data value B′ of instruction i1 with the predicted result data value B_{pred} for instruction i1, and signal a misprediction if there is a mismatch. If the value predictions are correct, the parallel execution of instructions i1-i3 gives an IPC greater than 1, speeding up performance compared to the execution in absence of value prediction.

As shown in FIG. 1, flush control circuitry 28 is provided to control flushing of instructions and micro-operations from the processing pipeline 4 if a misprediction is detected (either based on an incorrect branch prediction by branch predictor 19, or based on an incorrect value prediction by value prediction circuitry 26). When a flush is required, the flush control circuitry 28 determines the point of program flow associated with the misprediction, and triggers a flush of all instructions/micro-operations younger (later in program order) than the misprediction point, so that those instructions can be re-fetched by the fetch stage 6 and processed once more based on the correct outcome for the mispredicted instruction. For the branch predictor 19, the misprediction penalty is cheap because, in absence of making any branch prediction, the delay in waiting until a branch outcome is actually known before fetching subsequent instructions by the fetch stage 6 would be many cycles, similar to the penalty of dealing with a branch misprediction. In contrast, for the value prediction circuitry 26, the misprediction penalty is extremely high because when a value predicted instruction is incorrectly predicted, this triggers flushing of younger instructions which incurs a large delay in re-fetching all of those instructions from the fetch stage 6, waiting for those instructions to reach the execute stage 16 once more, and re-executing the instructions. This value misprediction delay affects instructions independent of the value predicted instruction which may nevertheless end up having to be re-fetched and re-executed (since flush control mechanisms may be limited to flushing the pipeline entirely of instructions beyond a given point of program flow, so even instructions younger than the misprediction point whose results were entirely correct may have to be re-executed), so it is not just instructions with incorrect results based on the value prediction that are flushed. The delay of resolving the value misprediction is typically much greater than the delay that would have been incurred had the value prediction never been made and the dependent instructions processed early based on a data value prediction simply waited for the result of the given instruction to actually become available at the execute stage 16.

Therefore, as the misprediction cost of value prediction is high, in practice to give a performance benefit, it can be important for value prediction accuracy to be extremely high (typically, over 99% accuracy). The tolerance for misprediction is much lower for value prediction than for branch prediction. This means that typical value prediction schemes may require a relatively costly value prediction table 27 to maintain sufficient value prediction state that accuracy can remain high enough to improve performance. That value prediction table 27 can be costly because typical schemes are based on storing the actual numeric values of predicted result data values for value-predicted instructions in the value prediction table, and as result data values (corresponding to destination registers of the value-predicted instructions) can be wide (e.g. 64 bits or more), this incurs a significant circuit area and energy cost, particularly as the value prediction table 27 should have sufficient entries not only to track reliable value predictions for instructions which can successfully be value-predicted, but also training entries which are undergoing training to check whether a confident value prediction is possible (but which may not ultimately succeed in the training). If the value prediction table 27 stores the actual predicted data values, this may also limit the utility of applying value prediction table to scenarios requiring multiple data values to be stored per instruction, such as prediction of different result data values for different loop iterations of the same instruction, prediction of results of multi-destination instructions such as load-multiple instructions, or prediction of vector result values of vector instructions, where a vector result for a given vector register 14-V is very wide and includes multiple independent vector elements in one register. Hence, there can be a significant barrier to entry in including value prediction circuitry 26 in a given design, limiting opportunities for improving performance by value prediction in an implementation with a limited power and circuit area budget.

In the examples below, the value prediction table 27, rather than tracking predicted result data values by storing the result data values themselves, stores register identifiers which reference registers of a register file 14 used by the processing circuitry (execute stage 16) for storing instruction operands and results. Hence, the register file 14 can be used as a store of predicted data values. This means the fields in the value prediction table 27 for tracking predicted data values can be much smaller, as a result-width field (e.g. 64 or more bits) can be reduced to a field of width corresponding to a register identifier (typically much smaller, e.g. 9 bits in one example, although the width of a register identifier can vary depending on the number of registers in the register file 14). As well as reducing the storage costs in the value prediction table 27, this also reduces the power costs of transferring information between the value prediction circuitry 26 and the execute stage 16, as narrower signal paths can be used to convey register identifiers between the value prediction stage 26 and the execute stage 16 compared to what would be needed to exchange full data values. Hence, this approach enables much more energy-efficient value prediction to be implemented, making it more feasible to introduce value prediction in an implementation with a given amount of circuit area and power budget.

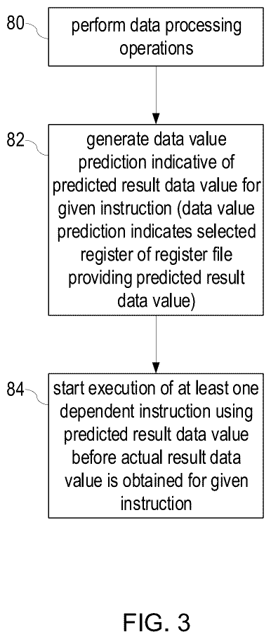

FIG. 3 illustrates a method of performing data value prediction. At step 80, the processing circuitry 16 performs data processing operations in response to instructions. At step 82, the value prediction circuitry 26 generates a data value prediction indicative of a predicted result data value predicted to be obtained by the processing circuitry in response to a given instruction. The value prediction circuitry uses the register file 14 as a store of predicted result data values. The data value prediction generated by the value prediction circuitry 26 indicates a selected register of the register file 14 from which the processing circuitry 16 is to obtain the predicted result data value when processing at least one dependent instruction. At step 84, the processing circuitry 16 starts execution of at least one instruction dependent on the given instruction, using the predicted result data value obtained from the selected register as a source operand, before an actual result data value is obtained by the processing circuitry 16 in response to the given instruction.

This value prediction technique using the register file 14 as a store of predicted data values could be applied to any value prediction circuitry 26, including value prediction circuitry which is trained based on outcomes of non-flushed instructions and/or value prediction circuitry which does not attempt to record predictions for multiple iterations of the same instruction.

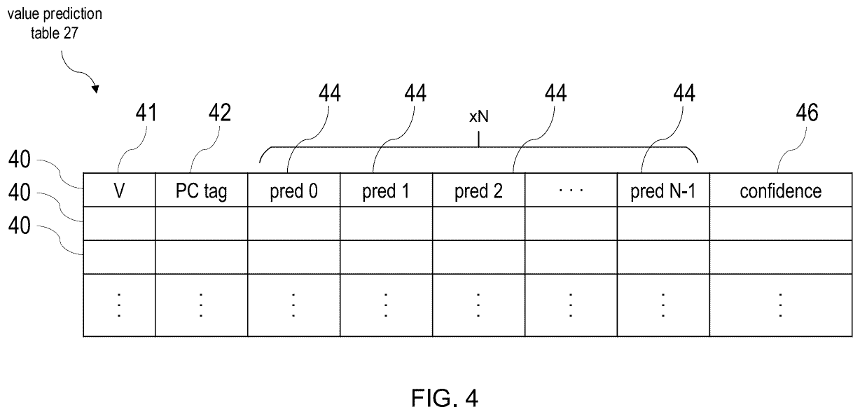

However, FIGS. 4 to 6 describes techniques for supporting a specific example of value prediction based on “replay prediction”, where result data values of instructions flushed from the pipeline by the flush control circuitry 28 due to a misprediction are used to train the value prediction table 27, so that on a subsequent attempt to re-execute (replay) the instruction following resolution of the misprediction, the value prediction circuitry 26 can predict the result data values of the replayed instructions (which have a reasonably high probability of giving the same result on the replayed attempt as on the previous attempt prior to the flush), reducing the cost of the misprediction and improving performance on the subsequent replay attempts. This approach can be beneficial because, particularly when executing program loops where the same sequence of instructions is executed for multiple iterations, it can be common that a misprediction identified for one iteration is not discovered that until many subsequent iterations have already speculatively executed, and the outcome of instructions in subsequent iterations may not necessarily be dependent on the instruction whose outcome was mispredicted in an earlier iteration, so that the results generated on the failed attempt of executing instructions for the subsequent iterations may still be the same when those iterations are replayed after the flush caused by the misprediction. As this approach is particularly useful for scenarios involving a program loop, it can be useful for the value prediction table 27 to include fields for recording multiple value predictions for respective instances of the same instruction at a given program counter address, so that different result values can be predicted for different iterations of the same instruction executed in a loop.

FIG. 4 illustrates an example of a value prediction table 27 that can be used by the value prediction circuitry 26 to generate value predictions. The value prediction table 27 includes a number of value prediction entries 40 each corresponding to an associated instruction. A given value prediction entry 40 comprises:
a valid field 41 indicating whether the given value prediction entry is valid;
a PC (program counter) tag field 42 for storing a tag value derived from a program counter address of the associated instruction, which is used on lookups of the value prediction circuitry 26 to determine whether the given value prediction entry 40 corresponds to a specified program counter address of an instruction being looked up in the table;
value prediction fields 44, pred0 to predN-1 (i.e. N value prediction fields in total, where N is an integer), each for storing prediction information identifying the predicted data value for a corresponding instance of the associated instruction. Each value prediction field 44 can store either a hash of a predicted result data value (in a training phase when confidence in the prediction entry 40 has not yet reached sufficient level to use the entry for generating value predictions) or a register identifier pointing to a physical register in the register file 14 which provides the corresponding predicted data value (in a prediction phase once training has completed).
a confidence field 46 storing a confidence value for tracking confidence in the predictions given by the value prediction entry 40. During a training phase, confidence is adjusted based on comparisons between a hash of a predicted result data value stored in a corresponding value prediction field 44 and a hash of an actual result data value computed by the execute stage 16 for a corresponding instance of executing the associated instruction. When the confidence reaches a given threshold (e.g. when the confidence value saturates), the training phase can be ended and result hashes recorded in the prediction fields 44 can, on a subsequent occasion when an instance of the associated instruction is encountered, be replaced with the register identifier of the physical register designated by the rename stage 11 for storing the result of that instruction.
   To distinguish different instances of executing the same instruction, the decode stage 10 can tag instances of an instruction (or micro-operation) at a given program counter address with an instance identifier which is used by the value prediction circuitry 26 to identify which of the value prediction fields 44 relates to a given instance of the associated instruction. For example, the decode stage 10 can maintain a set of instance counters corresponding to instructions with respective program counter addresses, which are incremented on each occasion an instance of the corresponding instruction is decoded, and on a flush event are reset to the instance identifier of the oldest flushed instance of the corresponding instruction. An instance counter may be reallocated to a different instruction and reset to zero if no instance of a given instruction allocated an instance counter has been encountered for some time.

In other examples, the branch predictor 19 could maintain a loop counter to track a number of loop iterations, e.g. a counter incremented on backwards taken branches and reset on a backwards branch that is not taken, and the loop counter could be used to generate the instance identifier assigned to respective instances of an instruction at a given program counter address. Hence, in some cases the assignment of instance identifier could take place at a stage other than the decode stage 10, e.g. at the fetch stage 6 based on information provided by the branch predictor 19.

Hence, the apparatus comprises instance identifier assignment circuitry for assigning an instance identifier for distinguishing respective instances of an instruction at a given program counter address. The instance identifier assignment circuitry could, for example, comprise any one or more of the branch predictor 19, the fetch stage 6, the decode stage 10 or any other pipeline stage that processes instructions in program order prior to the rename stage 11.

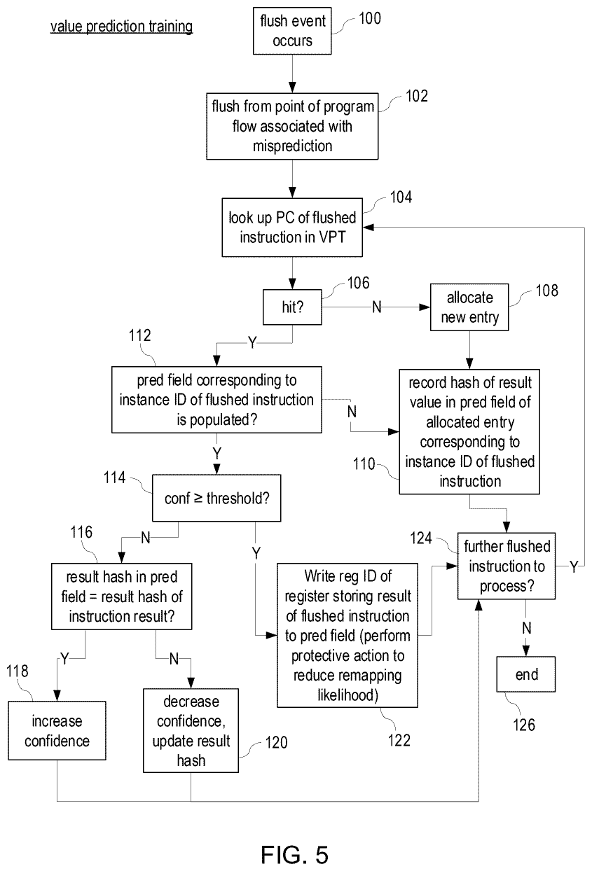

FIG. 5 illustrates a method for training the value prediction table 27 based on outcomes of flushed instructions flushed from the processing pipeline 4 following detection of a misprediction (which could be any misprediction, e.g. branch misprediction or value misprediction). In this example, training is based on flushed instructions and instructions which encounter a value misprediction (non-flushed instructions which commit without being flushed and are not subject to value misprediction do not influence the training of the value prediction table 27).

At step 100, the flush control circuitry 28 detects a flush event triggered by a misprediction. At step 102, in response to the flush event, the flush control circuitry 28 flushes instructions or micro-operations from the pipeline 4 that are associated with points of program flow younger than the point of program flow at which the misprediction occurred.

A series of steps 104 to 124 are performed to perform value prediction training based on each flushed instruction that was flushed after reaching the execute stage 16 and obtaining a result data value (it is not necessary to perform these steps for flushed instructions which were flushed before the result data value becomes available). The steps are shown as a sequential loop in FIG. 5, but could also be performed at least partially in parallel to process multiple flushed instructions simultaneously. If the misprediction causing the flush event was due to a mispredicted value prediction by the value prediction circuitry 26, then steps 104 to 124 could also be performed for the instruction whose result data value was mispredicted by the value prediction circuitry 26 (even if that instruction would not itself be flushed from the pipeline), or alternatively another misprediction response action could be taken if there is a value misprediction (such as invalidating the value prediction entry 40 that caused the value misprediction to eliminate risk of that entry causing further value mispredictions). If steps 104 to 124 are performed for the mispredicted instruction subject to value prediction, then references to the “flushed instruction” below can also refer to that instruction even if that instruction is not itself flushed.

At step 104, the value prediction circuitry numerals 26 looks up the program counter address of a given flushed instruction in the value prediction table (VPT) 27. For example, for a fully-associative table structure, the value prediction circuitry 26 compares a tag value derived from the program counter (PC) address with the PC tag field 42 of each value prediction table entry 40 and detects a hit in the table if any value prediction table entry 40 has a PC tag field 42 matching the tag value derived from the program counter address of the flushed instruction. If a set-associative or direct-mapped scheme is used for the value prediction table 27, the tag comparison may only be performed for a subset of entries selected based on the PC address of the flushed instruction.

If the lookup misses in the value prediction table 27 (N at step 106), then at step 108 a new entry is allocated for the flushed instruction (replacing an old entry, if there is no invalid entry available for allocation—if an old entry needs to be replaced then a replacement policy can be used which prioritises for replacement an entry with lower confidence 46 and preserves the entries with higher confidence). At step 110, the value prediction circuitry 26 generates a hash value by applying a hash function to the actual result value obtained for the flushed instruction by the execute stage 16, and updates the newly allocated entry to record the hash value in the prediction field 44 which corresponds to the instance identifier (ID) of the flushed instruction (the instance identifier being allocated by the decode stage 10 to distinguish different instances of flushed instructions corresponding to different loop iterations).

On the other hand, if the lookup of the PC in the value prediction table 27 detects a hit against a given value prediction entry 40 (Y at step 106), then at step 112 the value prediction circuitry detects whether the prediction field 44 corresponding to the instance ID of the flushed instruction is already populated with either hash value or a register identifier. If not, then again at step 110 a hash value is generated from the result of the flushed instruction and written to the prediction field 44 of the given value prediction entry that corresponds to the instance ID of the flushed instruction.

If the prediction field 112 corresponding to the instance ID of the flushed instruction is already populated, then the value prediction circuitry 26 detects whether the confidence value 46 for the given value prediction entry 40 has reached the threshold required for using the given value prediction entry 40 to generate value predictions. If not, then the training phase is still pending and at step 116 the value prediction circuitry 26 compares the actual result hash value generated by applying the hash function to the actual result value obtained by execute stage 16 for the flushed instruction with the predicted result hash value stored in prediction field 44 corresponding to the instance ID of the flushed instruction. If the actual result hash value matches the predicted result hash value, then at step 118 the value prediction circuitry 26 increases the confidence indicated by the confidence field 46 of the given value prediction entry 40. If the actual result hash value does not match the predicted result hash value, then at step 120 the value prediction circuitry 26 decreases the confidence indicated by the confidence field 46 of the given value prediction entry 40.

If at step 114 the confidence was found to already have reached the threshold for useful predictions (i.e. the training phase has already completed for this entry), then at step 122 the value prediction circuitry 26 writes the physical register identifier of a selected physical register that stores the actual result value of the flushed instruction to the prediction field 44 that corresponds to the instance ID of the flushed instruction. The value prediction circuitry 26 may also trigger a protective action to reduce the likelihood of that selected physical register being reclaimed by the register rename circuitry 11 for remapping to a logical destination register of an instruction. For example, the value prediction circuitry 26 may trigger a reduction in priority with which the selected physical register is selected for reclaim (e.g. by demoting the register to the bottom of the free list 24), or by triggering a register move to move the actual result value of the flushed instruction from a physical register allocated as the destination register of the flushed instruction to a physical register in a reserved portion of the register file 14 that is reserved for storing predicted result values and cannot be mapped by the rename circuitry 11 to the destination logical register of an instruction (in that case, the register identifier written to the value prediction table 27 will be the register identifier of the selected register in the reserved portion of the register file 14).

At step 124, the value prediction circuitry checks whether there are any further flushed instructions to process for training the value prediction table 27. If so, steps 104 to 124 are performed again for that flushed instruction. When there are no further flushed instructions to process, the current training run ends at step 126, and the value prediction circuitry 26 awaits a further flush event.

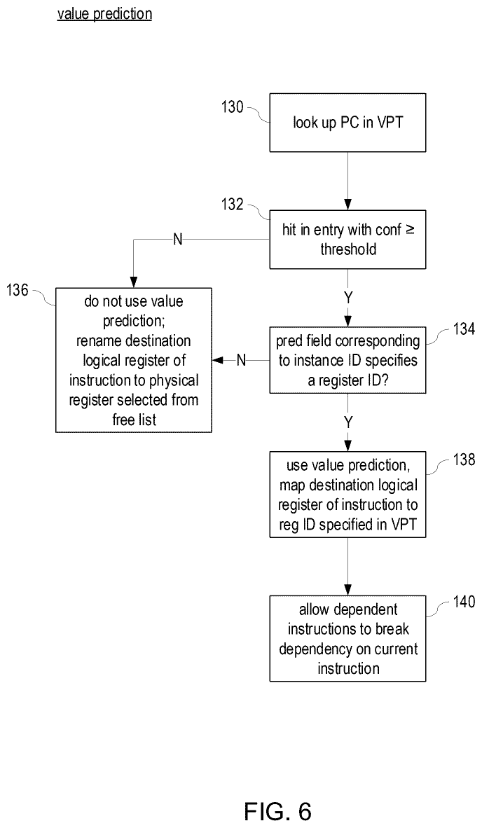

FIG. 6 illustrates steps for generating value predictions based on the value prediction table 27. When a given instruction reaches the rename stage 11, at step 130 the value prediction circuitry looks up the program counter address of the instruction in the value prediction table 27. At step 132, the value prediction circuitry 26 determines, based on comparison of a tag value derived from the PC address of the instruction with PC tags 42 in one or more value prediction entries 40 whether there is a hit in any entry whose training phase has already ended successfully (i.e. a hit in an entry having a confidence 46 that has reached the threshold for useful predictions). If the PC address of the given instruction misses in the table 27 altogether, or only hits in an entry 40 that has insufficient confidence 46, then at step 136 the value prediction circuitry 26 determines that value prediction should not be applied to this instruction. Instead, the rename circuitry 11 maps the destination logical register of the instruction to a physical register selected based on the free list 24.

If the PC address of the instruction hits in an entry with sufficient confidence 46, at step 134 the value prediction circuitry 26 determines whether the prediction field 44 corresponding to the instance ID of the given instruction specifies a register identifier or a predicted result hash value. If the corresponding prediction field 44 specifies a result hash value, then at step 136 again no value is used for value prediction (as the predicted result data value itself cannot be reverse engineered from the stored hash value), and again the rename circuitry 11 selects a new physical register to map to the destination logical register of the given instruction. If this instruction ends up being flushed, that physical register may end up being used to hold a predicted result data value with its register identifier written to the value prediction table at step 122 of FIG. 5 as discussed above. Some implementations could, if desired, choose to update the value prediction table with the specified register identifier at step 136 of FIG. 6 instead of waiting until the instruction is processed for training at step 122 of FIG. 5.

If the PC address of the instruction hits in entry with sufficient confidence and the prediction field 44 corresponding to the instance ID of the given instruction specifies a register identifier (Y at step 134), then at step 138 the value prediction circuitry 26 determines that value prediction can be used for predicting the result data value of this instruction, and controls the register rename circuitry to map the destination logical register of the instruction to the physical register identified by the register identifier stored in the corresponding prediction field 44 corresponding to the instance ID of the given instruction. At step 140, the value prediction circuitry 26 issues signals to the subsequent stages of the pipeline (e.g. to issue stage 12), to indicate that any instructions dependent on the given instruction are allowed to break their dependency. For example, the issue stage 12 can then issue an instruction dependent on the given instruction without waiting for the given instruction to actually generate its result.

Even if a protective measure is applied to protect physical registers identified in the value prediction table 27 as providing predicted result values against reclaim, there could still be a risk that such physical registers may need to be reclaimed and reallocated by the rename stage 11. For example, even if physical registers used to hold predicted data values are at lower probability of being reclaimed, if there are no other physical registers available in the free list 24, it may be undesirable to stall the pipeline merely to preserve the data value predictions, and so the rename circuitry 11 may then select for reallocation a physical register that is being used to hold a data value prediction. If a physical register referenced in one of the prediction fields 44 of the value prediction table 27 is reallocated, that corresponding prediction field 44 would need to be invalidated as there is a risk that a data value subsequently written to that physical register would not be the correct result data value of the instruction associated with the PC tag 42 of the corresponding value prediction entry 40. Sweeping the value prediction table 27 to check for occurrences of a register identifier of a reclaimed physical register may be relatively inefficient, both in time and in power consumption.

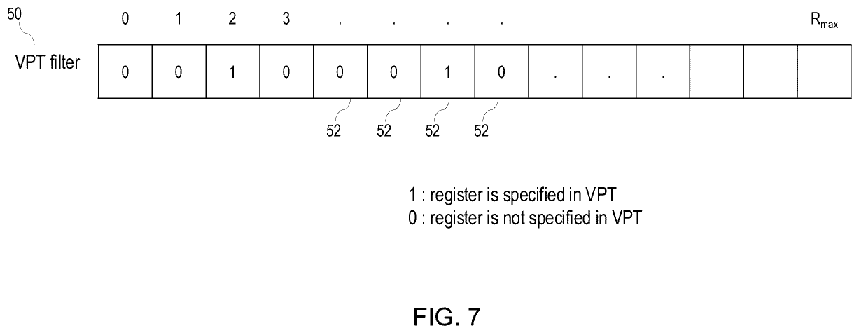

Therefore, as shown in FIG. 7 the value prediction circuitry 26 could maintain a filter structure 50 which can be looked up to determine which physical registers are currently identified in at least one prediction value field 44 of the value prediction table 27. In this example, the filter structure 50 includes a number of bits 52 each corresponding to a respective physical register and indicating whether that register is specified in any one or more prediction value fields 44 of the value prediction table 27. At step 122 of FIG. 5 or step 136 of FIG. 6, when any prediction value field 44 is updated to specify the register identifier of a given physical register, the corresponding bit 52 of the value prediction filter 50 is set to indicate that the register is present in the value prediction table 27. Hence, when a particular physical register is reclaimed for reallocation by the rename stage, the filter structure 50 can be looked up and if the filter structure bit 52 for the reclaimed physical register is set to indicate that the register does not appear in the value prediction table 27, the invalidation sweep of the value prediction table 27 can be suppressed. The filter structure 50 might be subject to false positive indications that a register is identified in the value prediction table 27 even though in fact that register is no longer identified, as the clearing of bits 52 on invalidation or replacement of register identifiers in the table may not necessarily be precise. Nevertheless, enabling at least some invalidation sweeps to be suppressed when it is known that the reclaimed physical register definitely cannot be present in the value prediction table 27 can be beneficial to save power by eliminating some unnecessary invalidation sweeps. While FIG. 7 shows one example filter structure, other examples could also be used (e.g. a Bloom filter which can allow the filter structure 50 to be reduced in size to less than one bit per physical register).

While FIG. 4 shows a table with one prediction field 44 per instance (loop iteration) of the associated instruction, other examples may support two or more prediction fields 44 per instruction instance, to help support value predictions for load-multiple instructions or other instructions with multiple destination registers.

In some examples, the register file used to provide the value predictions is the vector register file 14-V, so that the value prediction circuitry 26 can be used to predict result vectors of vector processing instructions or vector load instructions.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

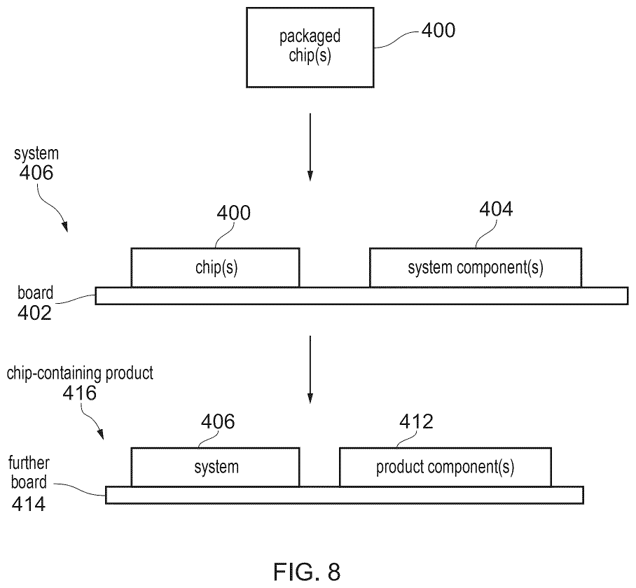

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus comprising:
   processing circuitry to perform data processing operations in response to instructions;
   a register file comprising registers configured to store operands for instructions processed by the processing circuitry; and
   value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
   the value prediction circuitry is configured to use the register file as a store of predicted result data values; and
   the data value prediction generated by the value prediction circuitry indicates a selected register of the register file from which the processing circuitry is to obtain the predicted result data value when processing the at least one dependent instruction.
2. The apparatus according to clause 1, in which the value prediction circuitry is configured to maintain a value prediction table comprising at least one value prediction entry, each value prediction entry comprising at least one value prediction field; and
   the value prediction circuitry is configured to generate, for the given instruction, the data value prediction specifying a register identifier read from a value prediction field of an entry of the value prediction table corresponding to the given instruction.
3. The apparatus according to clause 2, in which each value prediction field has fewer bits than a number of bits in the predicted result data value.
4. The apparatus according to any of clauses 2 and 3, in which during a training phase, the value prediction circuitry is configured to record, in a given value prediction field of the given value prediction entry, a result hash value obtained by applying a hash function to a result data value obtained by the processing circuitry for an associated instruction associated with the given value prediction entry.
5. The apparatus according to clause 4, in which during the training phase the value prediction circuitry is configured to adjust confidence in the given value prediction entry based on a comparison of the result hash value with an actual result hash value obtained by the processing circuitry by applying the hash function to an actual result data value obtained by the processing circuitry for the associated instruction.
6. The apparatus according to any of clauses 4 and 5, in which following completion of the training phase, in response to detecting a given instance of the associated instruction when a given value prediction field corresponding to the given instance of the associated instruction specifies the result hash value, the value prediction circuitry is configured to replace the result hash value stored in the given value prediction field with a register identifier identifying a register of the register file assigned to store an actual result data value obtained by the processing circuitry for the given instance of the associated instruction.
7. The apparatus according to any of clauses 2 to 6, in which in response to detecting a given instance of an associated instruction associated with a given value prediction entry after a training phase is complete for the given value prediction entry, when a given value prediction field of the given value prediction entry corresponding to the given instance of the associated instruction specifies a given register identifier identifying a given register, the value prediction circuitry is configured to break a dependency between the given instance of the associated instruction and at least one dependent instruction to enable the dependent instruction to execute using the given register as a source register before an actual result data value for the given register is obtained by the processing circuitry in response to the given instance of the associated instruction.
8. The apparatus according to any of clauses 2 to 7, in which each value prediction entry comprises a plurality of value prediction fields corresponding to respective instances of processing an associated instruction.
9. The apparatus according to clause 8, in which the respective instances of processing the associated instruction correspond to different loop iterations.
10. The apparatus according to any of clauses 8 and 9, comprising instance identifier assignment circuitry configured to assign, to an instruction associated with a given program counter address, an instance identifier for distinguishing respective instances of the instruction associated with the given program counter address; and
   the value prediction circuitry is configured to select between the value prediction fields of a given value prediction entry based on the instance identifier associated with an instruction associated with the given value prediction entry.
11. The apparatus according to any of clauses 2 to 10, comprising register rename circuitry to map logical registers referenced by instructions to physical registers of the register file;
   wherein the register rename circuitry is configured to perform a protective action to reduce probability of a given physical register identified in the value prediction table being remapped for storing a value other than the given predicted data value.
12. The apparatus according to clause 11, wherein the protective action comprises reducing a reclaim priority with which the given physical register is selected for being remapped.
13. The apparatus according to clause 11, wherein the protective action comprises designating, as the given physical register identified in the value prediction table for providing the given predicted data value, a register in a protected portion of the register file which is reserved for representing said store of predicted data values.
14. The apparatus according to any of clauses 2 to 13, wherein in response to a given physical register, which is identified in the value prediction table as representing a given predicted data value, being remapped for storing a value other than the given predicted data value, the value prediction circuitry is configured to invalidate at least one value prediction field identifying the given physical register in the value prediction table.
15. The apparatus according to clause 14, in which in response to the given physical register being remapped for storing a value other than the given predicted data value, the value prediction circuitry is configured to:
   look up a filter structure to identify whether the given physical register is identified in the value prediction table; and
   in response to the lookup of the filter structure identifying that the given physical register is identified in the value prediction table, trigger a search procedure to search for any value prediction fields identifying the given physical register which are to be invalidated.
16. The apparatus according to any of clauses 2 to 15, wherein the value prediction circuitry is configured to maintain the value prediction table based on training performed based on result data values obtained by the processing circuitry for flushed instructions which are flushed from a processing pipeline following detection of a misprediction.
17. The apparatus according to any of clauses 1 to 16, wherein in response to a given type of instruction specifying a plurality of destination registers for storing a plurality of result data values to be obtained in response to the given type of instruction, the value prediction circuitry is capable of generating data value predictions for at least two of the result data values of a given instance of the given type of instruction.
18. The apparatus according to any of clauses 1 to 17, wherein the register file comprises a vector register file comprising vector registers, and the value prediction circuitry is capable of generating the data value prediction indicative of a selected vector register of the vector register file from which the processing circuitry is to obtain a predicted vector result data value when processing the at least one dependent instruction.
19. A system comprising:
   the apparatus of any of clauses 1 to 18, implemented in at least one packaged chip;
   at least one system component; and
   a board,
   wherein the at least one packaged chip and the at least one system component are assembled on the board.
20. A chip-containing product comprising the system of clause 19, wherein the system is assembled on a further board with at least one other product component.
21. A non-transitory computer-readable medium storing computer-readable code for fabrication of an apparatus comprising:
   processing circuitry to perform data processing operations in response to instructions;
   a register file comprising registers configured to store operands for instructions processed by the processing circuitry; and
   value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
   the value prediction circuitry is configured to use the register file as a store of predicted result data values; and
   the data value prediction generated by the value prediction circuitry indicates a selected register of the register file from which the processing circuitry is to obtain the predicted result data value when processing the at least one dependent instruction.
22. A method comprising:
   performing, using processing circuitry, data processing operations in response to instructions, based on operands stored in registers of a register file; and
   generating, using value prediction circuitry, a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
   the value prediction circuitry uses the register file as a store of predicted result data values; and
   the data value prediction generated by the value prediction circuitry indicates a selected register of the register file from which the processing circuitry is to obtain the predicted result data value when processing the at least one dependent instruction.

In the present application, the words “configured to...” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to perform data processing operations in response to instructions;
a register file comprising registers configured to store operands for instructions processed by the processing circuitry; and
value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
the value prediction circuitry is configured to use the register file as a store of predicted result data values; and
the data value prediction generated by the value prediction circuitry indicates a selected register of the register file from which the processing circuitry is to obtain the predicted result data value when processing the at least one dependent instruction.

2. The apparatus according to claim 1, in which the value prediction circuitry is configured to maintain a value prediction table comprising at least one value prediction entry, each value prediction entry comprising at least one value prediction field; and
the value prediction circuitry is configured to generate, for the given instruction, the data value prediction specifying a register identifier read from a value prediction field of an entry of the value prediction table corresponding to the given instruction.

3. The apparatus according to claim 2, in which each value prediction field has fewer bits than a number of bits in the predicted result data value.

4. The apparatus according to claim 2, in which during a training phase, the value prediction circuitry is configured to record, in a given value prediction field of the given value prediction entry, a result hash value obtained by applying a hash function to a result data value obtained by the processing circuitry for an associated instruction associated with the given value prediction entry.

5. The apparatus according to claim 4, in which during the training phase the value prediction circuitry is configured to adjust confidence in the given value prediction entry based on a comparison of the result hash value with an actual result hash value obtained by the processing circuitry by applying the hash function to an actual result data value obtained by the processing circuitry for the associated instruction.

6. The apparatus according to claim 4, in which following completion of the training phase, in response to detecting a given instance of the associated instruction when a given value prediction field corresponding to the given instance of the associated instruction specifies the result hash value, the value prediction circuitry is configured to replace the result hash value stored in the given value prediction field with a register identifier identifying a register of the register file assigned to store an actual result data value obtained by the processing circuitry for the given instance of the associated instruction.

7. The apparatus according to claim 2, in which in response to detecting a given instance of an associated instruction associated with a given value prediction entry after a training phase is complete for the given value prediction entry, when a given value prediction field of the given value prediction entry corresponding to the given instance of the associated instruction specifies a given register identifier identifying a given register, the value prediction circuitry is configured to break a dependency between the given instance of the associated instruction and at least one dependent instruction to enable the dependent instruction to execute using the given register as a source register before an actual result data value for the given register is obtained by the processing circuitry in response to the given instance of the associated instruction.

8. The apparatus according to claim 2, in which each value prediction entry comprises a plurality of value prediction fields corresponding to respective instances of processing an associated instruction.

9. The apparatus according to claim 8, in which the respective instances of processing the associated instruction correspond to different loop iterations.

10. The apparatus according to claim 8, comprising instance identifier assignment circuitry configured to assign, to an instruction associated with a given program counter address, an instance identifier for distinguishing respective instances of the instruction associated with the given program counter address; and
the value prediction circuitry is configured to select between the value prediction fields of a given value prediction entry based on the instance identifier associated with an instruction associated with the given value prediction entry.

11. The apparatus according to claim 2, comprising register rename circuitry to map logical registers referenced by instructions to physical registers of the register file;
wherein the register rename circuitry is configured to perform a protective action to reduce probability of a given physical register identified in the value prediction table being remapped for storing a value other than the given predicted data value.

12. The apparatus according to claim 2, wherein in response to a given physical register, which is identified in the value prediction table as representing a given predicted data value, being remapped for storing a value other than the given predicted data value, the value prediction circuitry is configured to invalidate at least one value prediction field identifying the given physical register in the value prediction table.

13. The apparatus according to claim 12, in which in response to the given physical register being remapped for storing a value other than the given predicted data value, the value prediction circuitry is configured to:
look up a filter structure to identify whether the given physical register is identified in the value prediction table; and
in response to the lookup of the filter structure identifying that the given physical register is identified in the value prediction table, trigger a search procedure to search for any value prediction fields identifying the given physical register which are to be invalidated.

14. The apparatus according to claim 2, wherein the value prediction circuitry is configured to maintain the value prediction table based on training performed based on result data values obtained by the processing circuitry for flushed instructions which are flushed from a processing pipeline following detection of a misprediction.

15. The apparatus according to claim 1, wherein in response to a given type of instruction specifying a plurality of destination registers for storing a plurality of result data values to be obtained in response to the given type of instruction, the value prediction circuitry is capable of generating data value predictions for at least two of the result data values of a given instance of the given type of instruction.

16. The apparatus according to claim 1, wherein the register file comprises a vector register file comprising vector registers, and the value prediction circuitry is capable of generating the data value prediction indicative of a selected vector register of the vector register file from which the processing circuitry is to obtain a predicted vector result data value when processing the at least one dependent instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of an apparatus comprising:
processing circuitry to perform data processing operations in response to instructions;
a register file comprising registers configured to store operands for instructions processed by the processing circuitry; and
value prediction circuitry configured to generate a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
the value prediction circuitry is configured to use the register file as a store of predicted result data values; and
the data value prediction generated by the value prediction circuitry indicates a selected register of the register file from which the processing circuitry is to obtain the predicted result data value when processing the at least one dependent instruction.

20. A method comprising:
performing, using processing circuitry, data processing operations in response to instructions, based on operands stored in registers of a register file; and
generating, using value prediction circuitry, a data value prediction indicative of a predicted result data value predicted to be obtained by the processing circuitry in response to a given instruction, to enable at least one instruction dependent on the given instruction to start executing using the predicted result data value before an actual result data value is obtained by the processing circuitry in response to the given instruction; in which:
the value prediction circuitry uses the register file as a store of predicted result data values; and
the data value prediction generated by the value prediction circuitry indicates a selected register of the register file from which the processing circuitry is to obtain the predicted result data value when processing the at least one dependent instruction.
